(19) United States
(12) Patent Application Publication
(10) Pub. No.: US 2025/0002698 A1
(43) Pub. Date: Jan. 2, 2025

(54) POLYMER RECYCLATE BLEND PRODUCT AND PROCESS

(71) Applicant: Equistar Chemicals, LP, Houston, TX (US)

(72) Inventors: Richard P. Schmidt, South Lebanon, OH (US); Todd C. Brannon, Cincinnati, OH (US)

(73) Assignee: Equistar Chemicals, LP, Houston, TX (US)

(21) Appl. No.: 18/752,450

(22) Filed: Jun. 24, 2024

Related U.S. Application Data
(60) Provisional application No. 63/523,574, filed on Jun. 27, 2023.

(51) Int. Cl. C08L 23/06; C08K 3/34; C08K 5/13; C08K 5/524

(52) U.S. Cl. CPC C08L 23/06; C08K 3/34; C08K 5/13; C08K 5/524; C08L 2203/30; C08L 2205/025; C08L 2207/062; C08L 2207/20

(57) ABSTRACT

Provided are polymer recyclate blends having improved processability and/or organoleptic properties. The compositions comprise a homogenous matrix of a mixture of a polymer recyclate blend and an additive. The additive comprises an organic phosphite antioxidant, a hindered phenol antioxidant, a hydrophobic synthetic zeolite, or a combination thereof. Also provided are methods for making such compositions.

### PRIOR RELATED APPLICATIONS

This application claims the benefit of priority to U.S. Provisional Application No. 63/523,574, filed on Jun. 27, 2023, which is incorporated herein by reference in its entirety.

### FIELD OF THE INVENTION

The present disclosure relates to polymer recyclate blends having improved processability and/or organoleptic properties and methods for producing such products.

### BACKGROUND OF THE INVENTION

Polyolefins, in particular polyethylene, is increasingly consumed in large amounts for many applications, including packaging for food and other goods, electronics, automotive components, and a great variety of manufactured articles. Large amounts of waste plastic materials are presently coming from differential recovery of municipal plastic wastes, mainly constituted of flexible packaging (cast film, blown film and BOPP film), rigid packaging, blow molded bottles, and injection molded containers. Usually, recovery of polymer recyclate includes a step of separation of various types of polymers prior to further processing as post-consumer recycle (PCR) resins.

Some PCR resin suppliers carry a U.S. Food and Drug Administration (FDA) No-objection Letter (NOL) for food contact applications, including liquid food applications such as dairy, water, and juice packaging. Some such PCRs are advertised as recycled resin primarily comprising recycled homopolymer HDPE containers, such as gallon milk containers. However, testing of some of these PCRs via GC-MS, NMR, FTIR, and Liquid Chromatography Additives (LC ADDS) indicate the presence of trace amounts of cellulose, oxidized polymer, and other non-intentional added substances (NIAS) in the PCR resins.

When containers are molded from polymer blends comprising a portion of these PCRs, the trace amounts of these contaminates can potentially introduce unintended odors and/or flavors into liquid food contents stored in such container. Additionally, when compared to containers produced with all virgin polymers, the presence of these contaminants may result in molded containers having unfavorable aesthetics due to unintended yellowing and/or gel formation in the resin occurring during the molding process.

There is a need to provide processes for improved recycling of such PCR resins and to produce compositions comprising such recycled materials having a useful combination of properties that are equal to or better than analogous virgin compositions. Ideally, such processes would be highly flexible and could be implemented with commonly used equipment and familiar techniques to produce a wide variety of products.

### SUMMARY OF THE INVENTION

The present disclosure relates to a composition comprising a homogenous matrix of a mixture of a polymer recyclate blend and an additive. The additive comprises an organic phosphite antioxidant, a hindered phenol antioxidant, a hydrophobic synthetic zeolite, or a combination thereof. The mixture is subjected to compounding conditions sufficient to produce the homogenous matrix of the polymer recyclate blend and the additive, wherein the composition has improved processability and/or organoleptic properties when compared to the polymer recyclate blend alone.

In some embodiments, the polymer recyclate blend comprises a polymer recyclate in an amount in the range of from 5 wt. % to 65 wt. % and a virgin HDPE component is present in an amount in the range of from 35 wt. % to 95 wt. %, wherein wt. % is based on the total weight of the polymer recyclate and the virgin HDPE component.

The disclosure further relates to a method for improving the processability and/or organoleptic properties of a first polymer recyclate blend. The method comprises forming a mixture of the first polymer recyclate blend with an additive. The additive comprises an organic phosphite antioxidant, a hindered phenol antioxidant, a hydrophobic synthetic zeolite, or combination thereof. The method further comprises subjecting the mixture to compounding conditions sufficient to form a second recyclate polymer blend, wherein the second recyclate polymer blend is a homogenous matrix of the first recyclate polymer blend and the additive.

The foregoing has outlined rather broadly the features and technical advantages of the present invention in order that the detailed description of the invention that follows may be better understood. Additional features and advantages of the invention will be described hereinafter, which form the subject matter of the claims of the invention. It should be appreciated by those skilled in the art that the conception and specific embodiments disclosed may be readily utilized as a basis for modifying or designing other molded structures and/or processes for carrying out the same purposes of the present invention. It should also be realized by those skilled in the art that such equivalent constructions do not depart from the spirit and scope of the invention as set forth in the appended claims. The novel features which are believed to be characteristic of the invention, both as to its structure and method of manufacture, together with further objects and advantages will be better understood from the following description.

### BRIEF DESCRIPTION OF THE DRAWINGS

The claimed subject matter may be understood by reference to the following description taken in conjunction with the accompanying drawings, in which like reference numerals identify like elements, and in which:

FIG. 1 shows a graphical representation of dairy mold processability and swell test results of polymer recyclate blends with additives according to embodiments of the present disclosure compared to virgin polymers and polymer recyclates without additives;

FIG. 2 shows a graphical representation of OCS gel count test results of polymer recyclate blends with additives according to embodiments of the present disclosure compared to virgin polymers and polymer recyclates without additives;

FIG. 3 shows a graphical representation of NIAS volatiles test results of polymer recyclate blends with additives according to embodiments of the present disclosure compared to virgin polymers and polymer recyclates without additives;

FIG. 4 shows a graphical representation of NIAS volatiles test results of polymer recyclate blends with various amounts of synthetic zeolite additive according to embodiments of the present disclosure;

FIG. 5 shows a graphical representation of color index test results of polymer recyclate blends with additives according to embodiments of the present disclosure compared to virgin polymers and polymer recyclates without additives;

FIG. 6 shows a spider chart of organoleptic attributes of various blends of virgin polymer, PCR, and synthetic zeolite additive; and

FIG. 7 shows the position of various blends of virgin polymer, PCR, and synthetic zeolite additive on a plot of positive and negative organoleptic attributes.

While the disclosed process and composition are susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the subject matter claimed below will now be disclosed. In the interest of clarity, some features of some actual implementations may not be described in this specification. It will be appreciated that in the development of any such actual embodiments, numerous implementation-specific decisions must be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase. It must also be noted that, as used in the specification and the appended claims, the singular forms “a,” “an,” and “the” include plural references unless otherwise specified.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

### Definitions

As used herein, “compounding conditions” means temperature, pressure, and shear force conditions implemented in an extruder to provide intimate mixing of two or more polymers and optionally additives to produce a substantially homogeneous polymer product. The compounding conditions will be such that the specific energy from the compounder from shear and/or added heat are sufficient to melt the polymer components and homogenize them.

As used herein, “HDPE” means high density polyethylene—i.e., ethylene homopolymers and ethylene copolymers produced in a suspension, solution, slurry, or gas phase polymerization process and having a density in the range of 0.940 g/cm³ to 0.970 g/cm³.

As used herein, “homogeneous,” with respect to the polymer blends, means a mixture in which the composition is uniform throughout the mixture. That is to say, that in a homogenous blend of two polymers, polymer chains of the two blend components are entangled and/or intertwined so as to form a blend composition having different properties than either of the blend constituents. In some embodiments, where the two blend components are miscible, the homogeneous blend of the two components can have a single phase structure and/or glass transition temperature.

As used herein, “non-intentional added substances (NIAS) material,” means trace substances present in polymer recyclate such as, but not limited to, cellulose, oxidized polymer, inks, coatings, dust, organic waste, and other substances not present in a corresponding virgin polymer. NIAS material is inherently present in polymer recyclate as complete removal of such contaminants would be cost prohibitive using current technologies for separating used polymers from other waste materials.

As used herein, “organoleptic properties” refers to one or more sensory properties related to a polymer product, including one or more of appearance, flavor, aroma, texture, and sound. In particular, appearance can relate to any unintended coloration of the polymer product. Flavor can relate to any unintended alteration of the taste of a food or liquid exposed to a polymer product. Aroma can relate to any unintended alteration of the smell of a food or liquid exposed to a polymer product and/or any unintended odor of the polymer product itself.

As used herein, “polymer recyclate” means post-consumer recycled (“PCR”) polyolefin and/or post-industrial recycled (“PIR”) polyolefin. Polyolefin recyclate is derived from an end product that has completed its life cycle as a consumer item and would otherwise be disposed of as waste (e.g., a polyethylene water bottle) or from plastic scrap that is generated as waste from an industrial process. Post-consumer polymers include polymers that have been collected in commercial and residential recycling programs, including flexible packaging (cast film, blown film and BOPP film), rigid packaging, blow molded bottles, and injection molded containers. Usually, through a step of separation from other polymers, such as PVC, PET or PS, two main polyolefinic fractions are obtained, namely polyethylene recyclate (including HDPE, MDPE, LDPE, and LLDPE) and polypropylene recyclate (including homopolymers, random copolymers, and heterophasic copolymers). Polyethylene recyclate can be further separated to recover a portion having HDPE as the primary constituent. In addition to contamination from dissimilar polymers, HDPE recyclate frequently contains other impurities such as PMMA, PC, wood, paper, textile, cellulose, food, and other organic wastes, many of which cause the HDPE recyclate to have an unpleasant odor before and after typical processing.

As used herein, “processability” refers to how well a polymer composition can be molded by blow molding, injection molding, and/or compression molding into a molded article of commercial quality at commercially acceptable rates using common equipment and conditions.

As used herein, “homogenous matrix” refers to the blend or mixture produced by subjecting the polymers and additives described herein to temperature, pressure, and shear force conditions implemented in the extruder or mixer sufficient to provide intimate mixing of a polymer recyclate blend and an additive component to produce a substantially homogeneous product. That is to say, that there is no chemical reaction or chemical alteration of the components of a compounded blend of polymers and additives other than minor amounts of polymer chain scission and/or crosslinking typical to a compounding process.

As used herein, “virgin,” with respect to HDPE and/or other polymers, means pre-consumer polymers. Pre-consumer polymers are obtained directly or indirectly from petrochemical feedstocks fed to a polymerization apparatus. Pre-consumer polyolefins can be subjected to post polymerization processes such as, but not limited to, extrusion, pelletization, visbreaking, and/or other processing completed before the product reaches the end-use consumer. In some embodiments, virgin HDPE may have a single heat history. In some embodiments, a virgin HDPE has more than one heat history. In some embodiments, a virgin HDPE comprises no additives. In some embodiments, a virgin HDPE comprises additives.

Molecular weight distribution (“MWD”), which is also called M_{z}/M_{w}, as well as the molecular weight averages (number-average molecular weight, Mₙ weight-average molecular weight, M_{w}, z-average molecular weight, M_{z}, and z+1 average molecular weight, M_{z+1}) are determined using a high temperature Polymer Char gel permeation chromatography (“GPC”), also referred to as size exclusion chromatography (“SEC”), equipped with a filter-based infrared detector, IR5, a four-capillary differential bridge viscometer, and a Wyatt 18-angle light scattering detector. Mₙ, M_{w}, M_{z}, and MWD are reported using the IR detector. Three Agilent PLgel Olexis GPC columns are used at 145° C. for the polymer fractionation based on the hydrodynamic size in 1,2,4-trichlorobenzene (TCB) with 300 ppm antioxidant butylated hydroxytoluene (BHT) as the mobile phase.

As used herein, “wt. %” means weight percent.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the disclosure.

### Polymer Recyclate Blends Having Improved Processability/Organoleptic Properties

In some embodiments, a composition comprises a homogenous matrix of a mixture of a polymer recyclate blend and an additive. The additive comprises an organic phosphite antioxidant, a hindered phenol antioxidant, a hydrophobic synthetic zeolite, or a combination thereof. The mixture is subjected to compounding conditions sufficient to produce the homogenous matrix of the polymer recyclate blend and the additive, wherein the composition has improved processability and/or organoleptic properties when compared to the polymer recyclate blend alone.

### —Polymer Recyclate Blends

In some embodiments, the polymer recyclate blend comprises a polymer recyclate and a virgin HDPE component. The polymer recyclate is present in the polymer recyclate blend in an amount in the range of from 5 wt. % to 65 wt. %, from 10 wt. % to 55 wt. %, from 15 wt. % to 45 wt. %, or from 20 wt. % to 35 wt. %. The virgin HDPE component is present in the polymer recyclate blend in an amount an amount in the range of from 35 wt. % to 95 wt. %, from 45 wt. % to 90 wt. %, 55 wt. % to 85 wt. %, or from 65 wt. % to 80 wt. %. The weight percentages are based on the weight of the polymer recyclate blend—i.e., the combined weight of the polymer recyclate and the virgin HDPE component.

In some embodiments, recyclate blends are produced by subjecting a mixture of a polymer recyclate and a virgin HDPE component to compounding conditions sufficient to form a homogeneous polymer blend product. In some embodiments, compounding conditions are implemented in the compounding zone of an extruder or mixer and are tailored for mixtures of specific polymers and optionally additives. Temperature, pressure, and shear force conditions are implemented in the extruder or mixer sufficient to provide intimate mixing of a polymer recyclate and a virgin HDPE component to produce a substantially homogeneous polymer recyclate blend. The compounding conditions will be such that the specific energy from the compounder from shear and/or added heat are sufficient to melt the polymer components and homogenize them. In some embodiments, compounding conditions comprise a temperature in the compounding zone of less than or equal to 300° C., less than or equal to 250° C. or less than or equal to 200° C. In some embodiments, temperatures in the compounding zone can be in the range of from 125° C. to 195° C., from 130° C. to 180° C., or from 135° C. to 165° C.

In some embodiments, the composition, when compared to the same composition excluding the additive or the composition prior to compounding with the additive, exhibits one or more of:
i) a reduced diameter swell (Ud) and/or weight swell (Uw), as measure by the Uniloy™ 5630 Dairy Mold Processability and Swell Test;
ii) a reduced gel content by a range of 1 to 99%, as measured by the Optical Controls System (OCS) Gel Count;
iii) a reduction in volatile organic compounds (VOC) content from non-intentional added substances (NIAS) by a range of 1 to 99%, as measured by gas chromatography-mass spectrometry (GC-MS); and
iv) a reduction in yellowness by a range of 1 to 99%, as measured by Color Index Testing (CIT, L*a*b*).

In some embodiments, wherein the additive is a combination of the hindered phenol antioxidant and the organic phosphite antioxidant, the composition, when compared to the same composition excluding the additive or the composition prior to compounding with the additive, exhibits a reduction in yellowness.

In some embodiments, wherein the additive is the hydrophobic synthetic zeolite, the composition, when compared to the same composition excluding the additive or the composition prior to compounding with the additive, exhibits a reduction in VOC content.

### —Polymer Recyclate

In some embodiments, the polymer recyclate comprises HDPE in an amount greater than or equal to 80 wt. %, greater than or equal to 90 wt. %, greater than or equal to 95 wt. %, or greater than or equal to 99 wt. %, based on the polymeric portion of the polymer recyclate—i.e., excluding NIAS material. In some embodiments, the polymeric component of the polymer recyclate is substantially all HDPE. In some embodiments the HDPE is all or substantially all HDPE homopolymer.

In some embodiments, HDPE recyclate is derived from ethylene homopolymers, copolymers of units derived from ethylene and units derived from one or more of C₃-C₁₂ α-olefins, copolymers of units derived from ethylene and units derived from one or more of alpha mono-olefins. Such C₃-C₁₂ α-olefins include, but are not limited to, substituted or unsubstituted C₃ to C₁₂ alpha olefins such as propylene, butene, pentene, hexene, heptene, octene, nonene, decene, undecene, dodecane, and isomers thereof. When present, comonomers can be present in amounts up to 20 wt. %, 15 wt. %, 10 wt. %, or 5 wt. %.

In some embodiments, HDPE recyclate can be derived as a portion of post-consumer recycled polyolefin and/or post-industrial recycled polyolefin that is predominately comprised of HDPE recyclate, wherein “predominately” means greater than or equal to 80 wt. %, greater than or equal to 85 wt. %, greater than or equal to 90 wt. %, or greater than or equal to 95 wt. %, and up to about 100 wt. %, based on the total weight of the HDPE recyclate. The balance of the HDPE recyclate can be one or more other polyethylene recyclates, including, but not limited to, MDPE, LDPE, LLDPE, or a combination thereof.

Such ethylene homopolymers and/or copolymers can be produced in a suspension, solution, slurry, or gas phase process, using known equipment and reaction conditions. In some embodiments, polymerization temperatures range from about 0° C. to about 300° C. at atmospheric, subatmospheric, or superatmospheric pressures.

Slurry or solution polymerization systems can utilize subatmospheric or superatmospheric pressures and temperatures in the range of about 40° C. to about 300° C. An exemplary liquid phase polymerization system is described in U.S. Pat. No. 3,324,095, the disclosure of which is fully incorporated by reference herein. Liquid phase polymerization systems generally comprise a reactor to which olefin monomer and catalyst composition are added, and which contains a liquid reaction medium for dissolving or suspending the polyolefin. The liquid reaction medium may consist of the bulk liquid monomer or an inert liquid hydrocarbon that is nonreactive under the polymerization conditions employed. Although such an inert liquid hydrocarbon need not function as a solvent for the catalyst composition or the polymer obtained by the process, it usually serves as solvent for the monomers employed in the polymerization. Among the inert liquid hydrocarbons suitable for this purpose are isopentane, hexane, cyclohexane, heptane, benzene, toluene, and the like. Reactive contact between the olefin monomer and the catalyst composition should be maintained by constant stirring or agitation. The reaction medium containing the olefin polymer product and unreacted olefin monomer is withdrawn from the reactor continuously. The olefin polymer product is separated, and the unreacted olefin monomer and liquid reaction medium are recycled into the reactor.

Gas phase polymerization systems can utilize superatmospheric pressures in the range of from 1 psig (6.9 kPag) to 1,000 psig (6.9 MPag), 50 psig (344 kPag) to 400 psig (2.8 MPag), or 100 psig (689 kPag) to 300 psig (2.1 MPag), and temperatures in the range of from 30° C. to 130° C. or 65° C. to 110° C. Gas phase polymerization systems can be stirred or fluidized bed systems. In some embodiments, a gas phase, fluidized bed process is conducted by passing a stream containing one or more olefin monomers continuously through a fluidized bed reactor under reaction conditions and in the presence of catalyst composition at a velocity sufficient to maintain a bed of solid particles in a suspended condition. A stream containing unreacted monomer is withdrawn from the reactor continuously, compressed, cooled, optionally partially or fully condensed, and recycled into the reactor. Product is withdrawn from the reactor and make-up monomer is added to the recycle stream. As desired for temperature control of the polymerization system, any gas inert to the catalyst composition and reactants may also be present in the gas stream.

In some embodiments, a catalyst based on a Group VIB metal is used. In some embodiments the catalyst is a chromium-based catalyst. Such HDPE homopolymers and/or copolymers have some long-chain branching and a density in the range of from 0.940 g/cm³ to 0.970 g/cm³.

In some embodiments, a Ziegler-Natta (ZN) catalyst is used. Such catalysts are based on a Group IVB transition metal compound and an organoaluminum compound (co-catalyst). Such transition metals, include, but not limited to, Ti, Zr, and Hf. Nonlimiting examples of ZN catalyst systems include TiCl₄+Et₃Al and TiCl₃+AlEt₂Cl. Such HDPE homopolymers and/or copolymers have some long-chain branching and a density in the range of from 0.940 g/cm³ to 0.970 g/cm³.

In some embodiments, HDPE recyclate, derived from all or substantially all HDPE, as described above, can be characterized by having:
i) a density in the range of from 0.940 g/cm³ to 0.970 g/cm³ (ASTM D4703);
ii) a melt index (I₂; 2.16 kg, 190° C.) in the range of from 0.10 g/10 min. less than or equal to 1.0 g/10 min. (ASTM D-1238);
iii) a molecular weight distribution (M_{w}/Mₙ) greater than 6.0, greater than 8.0, or greater than 10, and/or less than 25, less than 20, or less than 15;
iv) a weight average molecular weight greater than or equal to 100,000 daltons, greater than or equal to 150,000 daltons, greater than or equal to 200,000 daltons, or greater than or equal to 250,000 daltons, and/or less than or equal to 600,000 daltons, less than or equal to 500,000 daltons, less than or equal to 400,000 daltons, or less than or equal to 300,000 daltons;
v) a melt elasticity (ER) greater than or equal to 1.0, greater than or equal to 2.0, or greater than or equal to 3.0, and/or less than 8.0, less than 7.0, or less than 6.0; and
vi) a first VOC content.

### Virgin HDPE Component

In some embodiments, a virgin HDPE component comprises ethylene homopolymers or copolymers of units derived from ethylene and units derived from one or more of C₃-C₁₂ α-olefins, copolymers of units derived from ethylene and units derived from one or more of alpha mono-olefins. Such C₃-C₁₂ α-olefins include, but are not limited to, substituted or unsubstituted C₃ to C₁₂ alpha olefins such as propylene, butene, pentene, hexene, heptene, octene, nonene, decene, undecene, dodecane, and isomers thereof. When present, comonomers can be present in amounts of greater than 0 wt. % and up to 20 wt. %, 15 wt. %, 10 wt. %, or 5 wt. %.

In some embodiments, the virgin HDPE component can be predominately comprised of HDPE, wherein “predominately” means greater than or equal to 80 wt. %, greater than or equal to 85 wt. %, greater than or equal to 90 wt. %, or greater than or equal to 95 wt. %, and up to 100 wt. %, based on the total weight of the virgin HDPE component. The balance of the virgin HDPE component, if any, can be one or more other virgin polyethylenes, including, but not limited to, MDPE, LDPE, LLDPE, or a combination thereof.

Such ethylene homopolymers and/or copolymers can be produced in a suspension, solution, slurry, or gas phase process, using known equipment and reaction conditions. In some embodiments, polymerization temperatures range from about 0° C. to about 300° C. at atmospheric, subatmospheric, or superatmospheric pressures.

Slurry or solution polymerization systems can utilize subatmospheric or superatmospheric pressures and temperatures in the range of about 40° C. to about 300° C. An exemplary liquid phase polymerization system is described in U.S. Pat. No. 3,324,095, the disclosure of which is fully incorporated by reference herein. Liquid phase polymerization systems generally comprise a reactor to which olefin monomer and catalyst composition are added, and which contains a liquid reaction medium for dissolving or suspending the polyolefin. The liquid reaction medium may consist of the bulk liquid monomer or an inert liquid hydrocarbon that is nonreactive under the polymerization conditions employed. Although such an inert liquid hydrocarbon need not function as a solvent for the catalyst composition or the polymer obtained by the process, it usually serves as solvent for the monomers employed in the polymerization. Among the inert liquid hydrocarbons suitable for this purpose are isopentane, hexane, cyclohexane, heptane, benzene, toluene, and the like. Reactive contact between the olefin monomer and the catalyst composition should be maintained by constant stirring or agitation. The reaction medium containing the olefin polymer product and unreacted olefin monomer is withdrawn from the reactor continuously. The olefin polymer product is separated, and the unreacted olefin monomer and liquid reaction medium are recycled into the reactor.

Gas phase polymerization systems can utilize superatmospheric pressures in the range of from 1 psig (6.9 kPag) to 1,000 psig (6.9 MPag), 50 psig (344 kPag) to 400 psig (2.8 MPag), or 100 psig (689 kPag) to 300 psig (2.1 MPag), and temperatures in the range of from 30° C. to 130° C. or 65° C. to 110° C. Gas phase polymerization systems can be stirred or fluidized bed systems. In some embodiments, a gas phase, fluidized bed process is conducted by passing a stream containing one or more olefin monomers continuously through a fluidized bed reactor under reaction conditions and in the presence of catalyst composition at a velocity sufficient to maintain a bed of solid particles in a suspended condition. A stream containing unreacted monomer is withdrawn from the reactor continuously, compressed, cooled, optionally partially or fully condensed, and recycled into the reactor. Product is withdrawn from the reactor and make-up monomer is added to the recycle stream. As desired for temperature control of the polymerization system, any gas inert to the catalyst composition and reactants may also be present in the gas stream.

In some embodiments, a catalyst based on a Group VIB metal is used. In some embodiments the catalyst is a chromium-based catalyst. Such HDPE homopolymers and/or copolymers have some long-chain branching and a density in the range of from 0.940 g/cm³ to 0.970 g/cm³. Such HDPE homopolymers and/or copolymers have some long-chain branching and a density in the range of from 0.925 g/cm³ to 0.940 g/cm³.

In some embodiments, a Ziegler-Natta (ZN) catalyst is used. Such catalysts are based on a Group IVB transition metal compound and an organoaluminum compound (co-catalyst). Such transition metals, include, but not limited to, Ti, Zr, and Hf. Nonlimiting examples of ZN catalyst systems include TiCl₄+Et₃Al and TiCl₃+AlEt₂Cl. Such HDPE homopolymers and/or copolymers have some long-chain branching and a density in the range of from 0.940 g/cm³ to 0.970 g/cm³.

Virgin HDPE can be characterized by having:
i) a density in the range of from 0.940 g/cm³ to 0.970 g/cm³ (ASTM D4703);
ii) a melt index (I₂; 2.16 kg, 190° C.) in the range of from 1.0 g/10 min. to 100 g/10 min., from 2.0 g/10 min. to 80 g/10 min., or from 3.0 g/10 min. to 50 g/10 min. (ASTM D-1238);
iii) a molecular weight distribution (M_{w}/Mₙ) greater than 15; and
iv) a weight average molecular weight less than or equal to 250,000 daltons, less than or equal to 200,000 daltons, less than or equal to 150,000 daltons, or less than or equal to 100,000 daltons.

### Additives

In some embodiments, an additive comprises an organic phosphite antioxidant, a hindered phenol antioxidant, a hydrophobic synthetic zeolite, or a combination thereof. In some embodiments, an additive comprises a combination of an organic phosphite antioxidant and a hindered phenol antioxidant. In some embodiments, an additive comprises a hydrophobic synthetic zeolite. In some embodiments, an additive comprises a combination of an organic phosphite antioxidant, a hindered phenol antioxidant, and a hydrophobic synthetic zeolite.

### —Organic Phosphite Antioxidant

In some embodiments, the composition can include, but are not limited to, one or more organic phosphite antioxidants. In some embodiments, suitable organic phosphites include one or more of tris(2,4-di-tert-butylphenyl)phosphite (Irgafos™ 168, available from BASF), di(2,4-di-tert-butylphenyl) pentaerithritol diphosphite (Ultranox™ 626, available from SI Group), 2,4,6-di-t-butylphenyl-2-butyl-2-ethyl-1,3-propanediol phosphite (Ultranox™ 641, available from SI Group), tetrakis(2,4-di-tert-butylphenyl)-4,4′-biphenylylenediphosphonite (Irgafos™ P-EPQ, available from BASF), tris [2-tert-butyl-4-thio(2′-methyl-4′-hydroxy-5-tertbutyl)phenyl-5-methyl-] phenylphosphite (Hostanox™, available from Clariant), 2,2′,2″-nitrilotriethyl-tris [3,3′,5,5′-tetra-tert-butyl-1,1′-biphenyl-2,2′-diyl] phosphite, 1,2-distearylpentaerylthritol diphosphite, and tris(nonylphenyl)phosphite.

In some embodiments, the organic phosphite antioxidant is present in the mixture in an amount in the range of from 10 ppmw to 5000 ppmw, from 25 ppmw to 4000 ppmw, from 50 ppmw to 3000 ppmw, from 75 ppmw to 2000 ppmw, or from 100 ppmw to 1000 ppmw, wherein ppmw is based on the total weight of the polymer recyclate and the virgin HDPE component;

### —Hindered Phenol Antioxidant

In some embodiments, the composition can include, but are not limited to, one or more hindered phenol antioxidants. In some embodiments, hindered phenol antioxidants include alkyl-radical scavengers, such as vitamin E, other tocopherols, and/or tocotrienols. In some embodiments, suitable hindered phenol antioxidant include one or more of triethylene glycol-bis [3-(3-tert-butyl-5-methyl-4-hydroxyphenyl) propionate] (Irganox™ 245, available from BASF), 1,6-hexanediol-bis[3-(3,5-di-tert-butyl-4-hydroxyphenyl) propionate (Irganox™ 259, available from BASF), 4-bis-(n-octylthio)-6-(4-hydroxy-3,5-di-tert-butylanilino)-1,3,5-triazine (Irganox™ 565, available from BASF), pentaerythrityl-tetrakis[3-(3,5-di-tert-butyl-4-hydroxyphenyl) propionate (Irganox™ 1010, available from BASF), 2,2-thio-diethylenebis[3-(3,5-di-tert-butyl-4-hydroxyphenyl) propionate] (Irganox™ 1035, available from BASF), octadecyl-3-(3,5-di-tert-butyl-4-hydroxyphenyl) propionate (Irganox™ 1076, available from BASF), N,N′-hexamethylenebis(3,5-di-tert-butyl-4-hydroxyhydrocinnamide) (Irganox™ 1098, available from BASF), 3,5-ditert-butyl-4-hydroxy-benzylphosphonate-diethyl ester (Irgamod™ 295, available from BASF), 1,3,5-trimethyl-2,4,6-tris(3,5-di-tert-butyl-4-hydroxybenzyl)benzene (Irganox™ 1330, available from BASF), tris-(3,5-di-tert-butyl-4-hydroxybenzyl) isocyanurate (Irganox™ 3114, available from BASF), octylated diphenylamine (Irganox™ 5057, available from BASF), 2,4-bis[(octylthio)methyl)-o-cresol (Irganox™ 1520L, available from BASF), isooctyl-3-(3,5-di-tert-butyl-4-hydroxyphenylpropionate (Irganox™ 1135, available from BASF), 2,4-bis(dodecylthiomethyl)-6-methylphenol (Irganox™ 1726, available from BASF), 2,5,7,8-tetramethyl-2-(4,8,12-trimethyltridecyl) chroman-6-ol, 3,4-Dihydro-2,5,7,8-tetramethyl-2-(4,8,12-trimethyltridecyl)-2H-1 (Irganox™ E201, available from BASF), and 5,7-di-tert-butyl-3-(3,4-dimethylphenyl)benzofuran-2 (3H)-1 (Irganox™ HP-136, available from BASF).

In some embodiments, the hindered phenol antioxidant is present in the mixture in an amount in the range of from 1 ppmw to 100 ppmw, from 5 ppmw to 75 ppmw, from 10 ppmw to 50 ppmw, from 15 ppmw to 40 ppmw, or from 20 ppmw to 30 ppmw, wherein ppmw is based on the total weight of the polymer recyclate and the virgin HDPE component;

### —Hydrophobic Synthetic Zeolite

In some embodiments, the composition can include, but are not limited to, one or more hydrophobic synthetic zeolites. In some embodiments, the one or more synthetic zeolites are built to selectively absorb ethylene. Unlike typical zeolites which readily absorb water, such synthetic zeolites only absorb ethylene and are impervious to water.

In some embodiments, a suitable hydrophobic synthetic zeolite comprises a 30% Zeolite silica-rich, powder identified by CAS #1318 Feb. 1. In some embodiments, compositions comprising suitable hydrophobic synthetic zeolites include, but are not limited to, PolyFresh™ EA2, available from LyondellBasell.

In some embodiments, the hydrophobic synthetic zeolite is present in the mixture in an amount in the range of from 0.1 wt. % to 6.0 wt. %, from 0.2 wt. % to 5.0 wt. %, from 0.3 wt. % to 4.0 wt. %, from 0.4 wt. % to 3.0 wt. %, or from 0.5 wt. % to 2.0 wt. %, wherein wt. % is based on the total weight of the polymer recyclate and the virgin HDPE component;

### —Compounding Conditions

In some embodiments, the compositions disclosed herein are produced by subjecting a mixture of a polymer recyclate blend and an additive as disclosed herein to compounding conditions sufficient to form a homogenous matrix of the polymer recyclate blend and the additive. In some embodiments, compounding conditions are implemented in the compounding zone of an extruder or mixer and are tailored for mixtures of specific polymers and optionally additives. Temperature, pressure, and shear force conditions are implemented in the extruder or mixer sufficient to provide intimate mixing of a polymer recyclate blend and an additive component to produce a substantially homogenous matrix. The compounding conditions will be such that the specific energy from the compounder from shear and/or added heat are sufficient to melt the polymer components and promote reaction of the additive component with the polymer melt. In some embodiments, compounding conditions comprise a temperature in the compounding zone of less than or equal to 300° C., less than or equal to 250° C. or less than or equal to 200° C. In some embodiments, temperatures in the compounding zone can be in the range of from 125° C. to 195° C., from 130° C. to 180° C., or from 135° C. to 165° C.

### —Method for Improving Processability/Organoleptics

In some embodiments, a method for improving the processability and/or organoleptic properties of a first polymer recyclate blend is disclosed. The method comprises forming a mixture of the first polymer recyclate blend with an additive. The additive comprises an organic phosphite antioxidant, a hindered phenol antioxidant, a hydrophobic synthetic zeolite, or a combination thereof. The mixture is subjected to compounding conditions sufficient to form a second recyclate polymer blend, wherein the second recyclate polymer blend is a homogenous matrix of the first recyclate polymer blend and the additive, and the first recyclate polymer blend and the additive are as described above.

In some embodiments, the second recyclate polymer blend, when compared to the first polymer recyclate blend, exhibits one or more of:
a) a reduced diameter swell (Ud) and/or weight swell (Uw), as measure by the Uniloy™ 5630 Dairy Mold Processability and Swell Test;
b) a reduced gel content by a range of 1 to 99%, as measured by the Optical Controls System (OCS) Gel Count;
c) a reduction in volatile organic compounds (VOC) content from non-intentional added substances (NIAS) by a range of 1 to 99%, as measured by gas chromatography-mass spectrometry (GC-MS); and
d) a reduction in yellowness by a range of 1 to 99%, as measured by Color Index Testing (CIT, L*a*b*).

### Certain Embodiments

In some embodiments, a composition comprises a homogenous matrix of a mixture of a polymer recyclate blend and an additive. The additive comprises an organic phosphite antioxidant, a hindered phenol antioxidant, a hydrophobic synthetic zeolite, or a combination thereof. The mixture is subjected to compounding conditions sufficient to produce the homogenous matrix of the polymer recyclate blend and the additive.

In some embodiments of the composition, in addition to the above limitations, the composition is further characterized by one or more of the following:
a) the polymer recyclate blend comprises:
   (1) a polymer recyclate in an amount in the range of from 5 wt. % to 65 wt. %, from 10 wt. % to 55 wt. %, from 15 wt. % to 45 wt. %, or from 20 wt. % to 35 wt. %, wherein in further embodiments, the polymer recyclate comprises a first HDPE in an amount greater than or equal to 80 wt. %, greater than or equal to 90 wt. %, greater than or equal to 95 wt. %, or greater than or equal to 99 wt. %, based on the weight of the polymer recyclate, wherein in yet further embodiments, the first HDPE is a homopolymer; and
   (2) a virgin HDPE component in an amount in the range of from 35 wt. % to 95 wt. %, from 45 wt. % to 90 wt. %, 55 wt. % to 85 wt. %, or from 65 wt. % to 80 wt. %, wherein in further embodiments, the virgin HDPE component comprises a second HDPE, which may be the same or different from the first HDPE, in an amount greater than or equal to 80 wt. %, greater than or equal to 90 wt. %, greater than or equal to 95 wt. %, or greater than or equal to 99 wt. %, based on the weight of the virgin HDPE component, wherein in yet further embodiments, the second HDPE is a homopolymer;
   wherein wt. % is based on the total weight of the polymer recyclate and the virgin HDPE component;
b) the organic phosphite antioxidant is present in the mixture in an amount in the range of from 10 ppmw to 5000 ppmw, from 25 ppmw to 4000 ppmw, from 50 ppmw to 3000 ppmw, from 75 ppmw to 2000 ppmw, or from 100 ppmw to 1000 ppmw, wherein ppmw is based on the total weight of the polymer recyclate and the HDPE;
c) the hindered phenol antioxidant is present in the mixture in an amount in the range of from 1 ppmw to 100 ppmw, from 5 ppmw to 75 ppmw, from 10 ppmw to 50 ppmw, from 15 ppmw to 40 ppmw, or from 20 ppmw to 30 ppmw, wherein ppmw is based on the total weight of the polymer recyclate and the HDPE;
d) the hydrophobic synthetic zeolite is present in the mixture in an amount in the range of from 0.1 wt. % to 6.0 wt. %, from 0.2 wt. % to 5.0 wt. %, from 0.3 wt. % to 4.0 wt. %, from 0.4 wt. % to 3.0 wt. %, or from 0.5 wt. % to 2.0 wt. %, wherein wt. % is based on the total weight of the polymer recyclate and the HDPE;
e) the compounding conditions are implemented in a compounding zone of an extruder or mixer and include one or more of temperature, pressure, and shear force;
f) the compounding conditions comprise a temperature less than or equal to 300° C., less than or equal to 250° C., less than or equal to 200° C., or in the range of from 125° C. to 195° C., from 130° C. to 180° C., or from 135° C. to 165° C.;
g) the organic phosphite antioxidant comprises di(2,4-di-tert-butylphenyl) pentaerithritol diphosphite;
h) the hindered phenol antioxidant comprises 2,5,7,8-tetramethyl-2-(4,8,12-trimethyltridecyl) chroman-6-ol;
i) the hydrophobic synthetic zeolite comprises a 30% Zeolite silica-rich, powder identified by CAS #1318 Feb. 1; and
j) the composition, when compared to the same composition excluding the additive, exhibits one or more of:
   (1) a reduced diameter swell (Ud) and/or weight swell (Uw), as measure by the Uniloy™ 5630 Dairy Mold Processability and Swell Test;
   (2) a reduced gel content by a range of 1 to 99%, as measured by the Optical Controls System (OCS) Gel Count;
   (3) a reduction in in volatile organic compounds (VOC) content from non-intentional added substances (NIAS) by a range of 1 to 99%, as measured by gas chromatography-mass spectrometry (GC-MS); and
   (4) a reduction in yellowness by a range of 1 to 99%, as measured by Color Index Testing (CIT, L*a*b*).

In some embodiments of the composition, in addition to the above limitations of the composition:
a) the additive is a combination of the hindered phenol antioxidant and the organic phosphite antioxidant; and
b) the composition exhibits a reduction in yellowness.

In some embodiments of the composition, in addition to the above limitations of the composition:
a) the additive is the hydrophobic synthetic zeolite; and
b) the composition exhibits a reduction in VOC content.

In some embodiments, a method for improving the processability and/or organoleptic properties of a first polymer recyclate blend is disclosed. The method comprises forming a mixture of the first polymer recyclate blend with an additive. The additive comprises an organic phosphite antioxidant, a hindered phenol antioxidant, a hydrophobic synthetic zeolite, or a combination thereof. The mixture is subjected to compounding conditions sufficient to form a second recyclate polymer blend, wherein the second recyclate polymer blend is a homogenous matrix of the first recyclate polymer blend and the additive.

In some embodiments of the method, in addition to the above limitations, the method is further characterized by one or more of the following:
a) the polymer recyclate blend comprises:
   (1) a polymer recyclate in an amount in the range of from 5 wt. % to 65 wt. %, from 10 wt. % to 55 wt. %, from 15 wt. % to 45 wt. %, or from 20 wt. % to 35 wt. %, wherein in further embodiments, the polymer recyclate comprises a first HDPE in an amount greater than or equal to 80 wt. %, greater than or equal to 90 wt. %, greater than or equal to 95 wt. %, or greater than or equal to 99 wt. %, based on the weight of the polymer recyclate, wherein in yet further embodiments, the first HDPE is a homopolymer; and
   (2) a virgin HDPE component in an amount in the range of from 35 wt. % to 95 wt. %, from 45 wt. % to 90 wt. %, 55 wt. % to 85 wt. %, or from 65 wt. % to 80 wt. %, wherein in further embodiments, the virgin HDPE component comprises a second HDPE, which may be the same or different from the first HDPE, in an amount greater than or equal to 80 wt. %, greater than or equal to 90 wt. %, greater than or equal to 95 wt. %, or greater than or equal to 99 wt. %, based on the weight of the virgin HDPE component, wherein in yet further embodiments, the second HDPE is a homopolymer;
   wherein wt. % is based on the total weight of the polymer recyclate and the virgin HDPE component;
b) the organic phosphite antioxidant is present in the mixture in an amount in the range of from 1 ppmw to 100 ppmw, from 5 ppmw to 75 ppmw, from 10 ppmw to 50 ppmw, from 15 ppmw to 40 ppmw, or from 20 ppmw to 30 ppmw, wherein ppmw is based on the total weight of the polymer recyclate and the virgin HDPE component;
c) the hindered phenol is present in the mixture in an amount in the range of from 10 ppmw to 5000 ppmw, from 25 ppmw to 4000 ppmw, from 50 ppmw to 3000 ppmw, from 75 ppmw to 2000 ppmw, or from 100 ppmw to 1000 ppmw, wherein ppmw is based on the total weight of the polymer recyclate and the virgin HDPE component;
d) the hydrophobic synthetic zeolite is present in the mixture in an amount in the range of from 0.1 wt. % to 6.0 wt. %, from 0.2 wt. % to 5.0 wt. %, from 0.3 wt. % to 4.0 wt. %, from 0.4 wt. % to 3.0 wt. %, or from 0.5 wt. % to 2.0 wt. %, wherein wt. % is based on the total weight of the polymer recyclate and the virgin HDPE component;
e) the compounding conditions are implemented in a compounding zone of an extruder or mixer and include one or more of temperature, pressure, and shear force;
f) the compounding conditions comprise a temperature less than or equal to 300° C., less than or equal to 250° C., less than or equal to 200° C., or in the range of from 125° C. to 195° C., from 130° C. to 180° C., or from 135° C. to 165° C.;
g) the organic phosphite antioxidant comprises di(2,4-di-tert-butylphenyl) pentaerithritol diphosphite;
h) the hindered phenol antioxidant comprises 2,5,7,8-tetramethyl-2-(4,8,12-trimethyltridecyl) chroman-6-ol;
i) the hydrophobic synthetic zeolite comprises a 30% Zeolite silica-rich, powder identified by CAS #1318 Feb. 1; and
j) the second polymer recyclate blend, when compared to the first polymer recyclate blend, exhibits one or more of:
   (1) a reduced diameter swell (Ud) and/or weight swell (Uw), as measure by the Uniloy™ 5630 Dairy Mold Processability and Swell Test;
   (2) a reduced gel content by a range of 1 to 99%, as measured by the Optical Controls System (OCS) Gel Count;
   (3) a reduction in volatile organic compounds (VOC) content from non-intentional added substances (NIAS) by a range of 1 to 99%, as measured by gas chromatography-mass spectrometry (GC-MS); and
   (4) a reduction in yellowness by a range of 1 to 99%, as measured by Color Index Testing (CIT, L*a*b*).

In some embodiments of the composition, in addition to the above limitations of the composition:
a) the additive is a combination of the hindered phenol antioxidant and the organic phosphite antioxidant; and
b) the composition exhibits a reduction in yellowness.

In some embodiments of the composition, in addition to the above limitations of the composition:
a) the additive is the hydrophobic synthetic zeolite; and
b) the composition exhibits a reduction in VOC content.

### EXAMPLES

The following examples are included to demonstrate embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Test Methods

### —Gel Content

Gel count refers to the number of gel particles present in a material, which can affect its mechanical properties and performance. GC-MS can be used to analyze the chemical composition of these gel particles and identify their sources, which can help to improve the manufacturing process and reduce the occurrence of gels.

Optical Control System (OCS) Gel Count is a method of determining polymer quality whereby a high-resolution camera takes pictures of the polymer and identifies and quantitates gels or imperfections. Gel count reported below was measured on a Collin™ Optical Control System (OCS) Cast Line with a FSA-100 film surface analyzer. The extruder was operated at a rate of 50 rpm, and melt temperatures for HDPE film were set to:

| | |
|---|---|
| Zone 1 | 180° C. |
| Zone 2 | 200° C. |
| Zone 3 | 210° C. |
| Zone 4 | 210° C. |
| Die | 210° C. |

The film analyzed was 2 mm in thickness and 3 m² in area. Software was configured to classify the gels and report out a composite gel count. Exemplary details of OCS and the composite gel count are provided in U.S. Pat. No. 7,393,916, the disclosure of which is fully incorporated by reference herein.

### Color Index

Color Index Testing (CIT) L*a*b* is a method for measuring color differences between compositions and/or articles described herein using a standard defined by Commission Internationale d′Eclairage (CIE) L*a*b* color coordinates. L* indicates lightness, a* is the red/green coordinate, and b* is the yellow/blue coordinate. The system was designed to be perceptually uniform with respect to human color vision. The standards used for the color difference can include virgin HDPE. The space itself is a 3-dimensional real-number space; therefore, any color variation can be expressed in L*a*b* coordinates. Deltas for L* (ΔL*), a* (Δa*) and b* (Δb*) may be positive (+) or negative (−):

ΔL*(L* sample minus L* standard)−difference in lightness and darkness (+=lighter,−=darker)

Δa*(a*sample minus a*standard)−difference in red and green(+=redder, −=greener)

Δb*(b*sample minus b*standard)−difference in yellow and blue(+=yellower, −=bluer)

The total difference between the compositions and/or articles and the standard is defined as Delta E (ΔE*) and is calculated using the following:

$$Δ E *= \sqrt{Δ L {*}^{2} + Δ a {*}^{2} + Δ b {*}^{2}}$$

Color index was measured on a Hunter Labscan™ XE. Tests were performed by adding approximately 100 g of sample pellets to a small clear cup enclosed by a black cap. Each sample cup was placed in the instrument and the test was run.

### —Processability and Swell

Uniloy™ 5630 processability: Bottle swell properties were determined using one gallon bleach-type bottles produced using a reciprocating Uniloy™ 5630 (single head) blow molder with the following heat settings as “standard conditions”:

| | |
|---|---|
| Feed | 166° C. |
| Transition | 177° C. |
| Meter1 | 190° C. |
| Meter2 | 190° C. |
| Head | 190° C. |
| Die | 190° C. |

The melt temperature under these conditions was 193° C. Screw speed was maintained at 26 rpm and the total cycle time was 15.4 seconds (10 seconds blow and 1.5 seconds parison drop). High-shear processability and swell changes were determined from bottles produced on a Uniloy™ 5630 intermittent extrusion blowmolder-1-gal milk/water bottles from homopolymers. Swell was measured by two methods. Weight swell was determined by the initial weight change observed for a test resin after transitioning from the control. Diameter swell was determined by measuring on an inlaid centimeter scale the distance of the flash down the handle of the bottle after the bottle weight had been reset at the target weight.

### —VOC Measurement

GC-MS for NIAS Volatiles are methods used to study the potential effects of reduced VOC emissions, yellowness, and gel count. Gas chromatography-mass spectrometry (GC-MS) is a powerful analytical technique used for the identification and quantification of volatile organic compounds (VOCs) in complex mixtures. GC-MS has been widely used for the analysis of non-intentionally added substances (NIAS) volatiles, which are chemical compounds that can be released from materials and products during their production, use, and disposal.

To perform GC-MS analysis, the sample is first injected into a gas chromatograph, which separates the different components of the sample based on their physical and chemical properties. The separated compounds are then directed to the mass spectrometer, where they are ionized and fragmented into smaller ions. The resulting mass spectra are used to identify the individual compounds based on their unique mass-to-charge ratios.

Samples provided were in either powder or pellet form and were prepared and analyzed in duplicate. Each sample was subjected to a static headspace gas chromatography (HS-GC) and separated in the gas phase. The volatile organic components in the samples were identified via mass spectrometer (MS). A 1.00 g+/−0.02 g aliquot of each sample was weighed into a 10 mL headspace vial, and the vial was sealed with an aluminum crimp-cap and Teflon-lined silicone septum. The actual sample weight may be recorded but was not required for the calculation of results. The samples were conditioned at 125° C. for 2 hours in a static headspace autosampler and analyzed via GC-MS.

GC-MS, or gas chromatography-mass spectrometry, was used to identify and quantify volatile organic compounds (VOCs) in a wide range of samples. This technique is particularly useful for analyzing non-intentionally added substances (NIAS) volatiles, which are chemical compounds that are not intentionally added to a product or material, but can be present as impurities or byproducts of manufacturing processes. In the context of studying the potential effects of reduced VOC emissions, GC-MS can be used to identify the specific VOCs that are present in a sample and determine their concentrations. This information can be used to compare the VOC emissions of different materials or products and assess the effectiveness of strategies to reduce VOC emissions. In addition to VOC emissions, GC-MS can also be used to study the properties of materials and products, such as yellowness and gel count. Yellowness is a measure of the degree of yellow coloration in a material, which can be caused by the presence of certain chemical compounds. GC-MS can be used to identify these compounds and determine their concentrations, which can help to understand the factors contributing to yellowness and develop strategies to reduce it.

### Materials Used in Experiments

### Starting Materials

Experiments were performed to evaluate additive formulations of PolyFresh™ EA2, Ultranox™ 626A, and Irganox™ E201 in incremental loading in polymer blends of 25 wt. % EcoPrime™ HDPE PCR and 75 wt. % Petrothene™ LM600700 HDPE. The formulations examined showed improvements in VOC, yellowness index, and/or gel reduction in some of the tested blends, by a range of 1 to 99%.

TABLE 1

| | | | Density | MI (I₂) | |
|---|---|---|---|---|---|
| Label | Composition | Grade | (g/cm³) | (dg/min) | Available from |
| HD1 | High density | Petrothene ™ | 0.960 | 0.80 | LyondellBasell, Houston, |
| | polyethylene (HDPE) | LM600700 HDPE | | | TX 77010, USA |
| PCR1 | Homopolymer High | EcoPrime ™ | 0.958-0.965 | 0.50-0.85 | Envision Plastics, |
| | Density Polyethylene | HDPE PCR | | | Reidsville, NC 27320, |
| | Post Consumer Resin | | | | USA |
| A1 | Organic phosphite | Ultranox ™ | n/a | n/a | SI Group, Bellevue, |
| | antioxidant | 626A | | | WA 98004, USA |
| A2 | Hindered phenol | Irganox ™ | n/a | n/a | BASF, Charlotte, NC |
| | antioxidant | E201 | | | 28273, USA |
| | (Vitamin E) | | | | |
| A3 | Hydrophobic synthetic | PolyFresh ™ | n/a | n/a | LyondellBasell, Houston, |
| | zeolite | EA2 | | | TX 77010, USA |

A1 and A2 have been researched to have mutual benefits in polyethylene and polypropylene degradation by reducing the production of potentially volatile organic compounds (VOC's) and other off-aroma and taste contaminates. The vitamin E component of A2 can produce a discoloration effect based on quinoidal byproducts. Therefore, A1 can be used as a secondary antioxidant to decrease this effect.

### Examples 1-9

The formulations in Examples 1-8, shown in Table 2, below, were compounded on a 26 mm Coperion™ twin screw compounding extruder to make pellets. HD1, PCR1, and various amounts of additives A1, A2, and A3 were combined at a screw rpm of at 200 with a zone 1 temperature set at 180° C. and zones 2-11 set at 250° C., and the die temperature set at 250° C. Extrudate exited a two hole die into a water bath to be cooled then into a pelletizer. These pellets were then injection molded into 4″×4″×0.125″ plaques on a BOY 22, BOY Machines, Inc. injection molding machine. Barrel temperature was set at 240° C., mold at 70° C., injection pressure was set at 80 bar, cooling was set for 25 seconds, and ejection force was set at 125 bar.

TABLE 2

| | HD1 | PCR1 | A1 | A2 | A3 |
|---|---|---|---|---|---|
| Example | (wt. %) | (wt. %) | (ppm) | (ppm) | (wt. %) |
| 1 | 100 | 0 | 0 | 0 | 0 |
| 2 | 75 | 25 | 0 | 0 | 0 |
| 3 | 75 | 25 | 0 | 0 | 0.5 |
| 4 | 75 | 25 | 0 | 0 | 1.0 |
| 5 | 75 | 25 | 0 | 0 | 2.0 |
| 6 | 75 | 25 | 25 | 0 | 0 |
| 7 | 75 | 25 | 25 | 100 | 0 |
| 8 | 75 | 25 | 25 | 500 | 0 |
| 9 | 75 | 25 | 25 | 1000 | 0 |

* Weight percentages and ppm loadings based on total weight of HD1 plus PCR1 as 100%.

### —Uniloy 5630 Dairy Mold Processability and Swell Testing

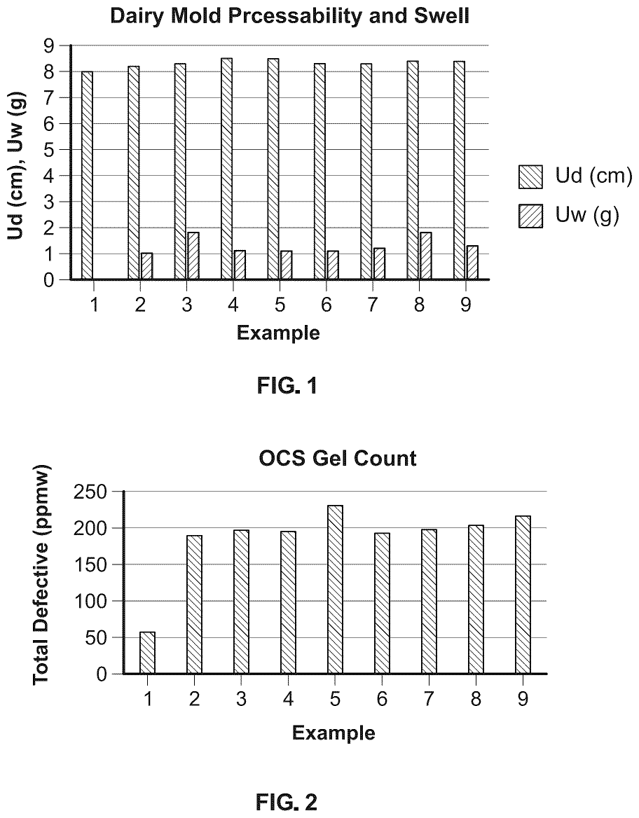

The Uniloy 5630 Diameter (Ud) and Weight (Uw) swell testing results for Examples 1-8 are shown in Table 3, below, and in FIG. 1. Swell testing for diameter swell (Ud) and weight swell (Uw) were conducted by using control resin HD1 of known swell characteristics. The Uniloy™ blow molder was operating at “standard conditions” as described above. 20 bottle measurements were taken with Ud swell averaging to 8.0 cm and Uw swell measuring 58.0 g. Each sample resin was then introduced to the extruder and allowed to run for 20 minutes to allow purging of a previous resin sample. 5 bottle weights were taken for Uw measurements. Mandrel die gap was adjusted to bottle weights at 58.0 g. 20 bottles were collected with average of 58.0 g weight and corresponding Ud were taken. Uw was calculated in the difference between the 5-bottle weight average and 58.0 g target. Swell testing was conducted under these conditions with dairy gallon mold for Uw of 58.0 gram and Ud of 8.0 cm.

TABLE 3

| Example | Ud (cm) | Uw (g) |
|---|---|---|
| 1 | 8.0 | 0.0 |
| 2 | 8.2 | 1.0 |
| 3 | 8.3 | 1.8 |
| 4 | 8.5 | 1.1 |
| 5 | 8.5 | 1.1 |
| 6 | 8.3 | 1.1 |
| 7 | 8.3 | 1.2 |
| 8 | 8.4 | 1.8 |
| 9 | 8.4 | 1.3 |

The overall trend was that the Ud and Uw values were slightly higher in inventive Examples 3-9 as compared to control Examples 1 and 2. Without wishing to bound by any particular theory, it is believed that the PCR1 component in Examples 2-9 is more contributes to higher swell characteristics than additives A1-A3. Variance in Ud and Uw values can range up to 0.2 cm and 0.5 g, respectively. Overall bottle production was considered good with no bottle blow outs or split parisons.

### —Optical Controls System (OCS) Gel Count

Table 4, below, and FIG. 2 show a comparison of OCS gel count results for Examples 1-9. Examples 1-9 were prepared for OCS gel count testing using a >250 microns screen pack with an observed area of 3 m² for defects >250 microns.

TABLE 4

| | Total Defective |
|---|---|
| Example | (ppm) |
| 1 | 56.8 |
| 2 | 189.2 |
| 3 | 196.5 |
| 4 | 194.4 |
| 5 | 230.4 |
| 6 | 193.1 |
| 7 | 197.8 |
| 8 | 203.2 |
| 9 | 216.3 |

Total defect area for ppm>250 microns for inventive Examples 3-5 (A3 formulations) indicated an increase gel count with increasing concentrations of additives from 0.0% to 2.0%. Gel content values for inventive Examples 3-5 exceeded those measured for control Examples 1 and 2.

Total defect area of inventive Examples 6-9 (A1/A2 formulations) indicated an increase gel count with increasing concentrations of A2. Gel content values for inventive Examples 6-9 exceeded those measured for control Examples 1 and 2.

These results could suggest a less favorable bottle appearance, as related to imperfections, such as black specks and/or inhomogeneous melt. Overall, Examples 3-5 (A3 formulations) and Examples 6-9 (A1/A2 formulations) illustrate a trend of some gel count values greater than Example 1 (HD1 control) but similar to Example 2 (PCR1/HD1 blend control), based on OCS Gel Count Total Defect ppm with a 250 micron screen pack.

### —NIAS Volatiles-GC-MS

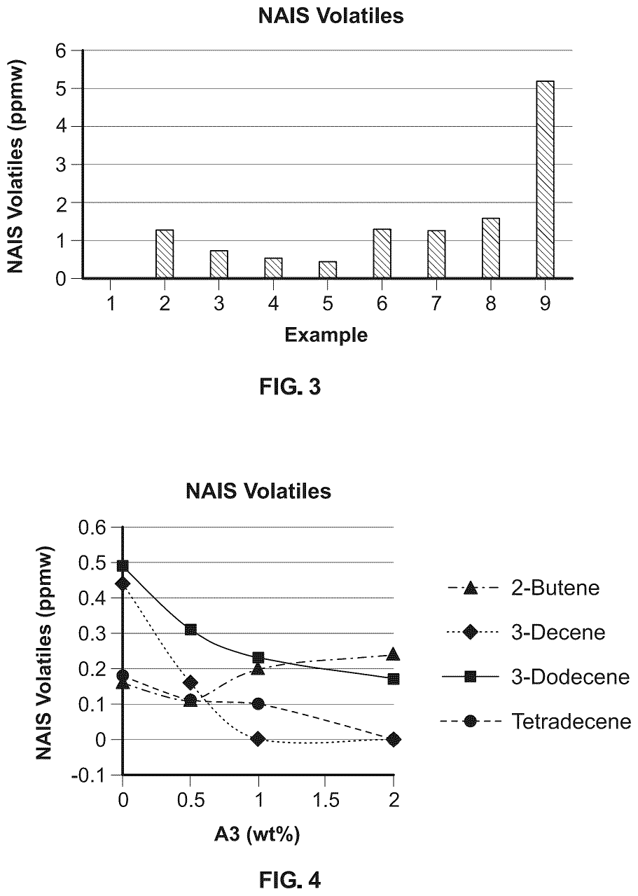

Tables 5 and 6, below, and FIG. 3 and FIG. 4, respectively, show a comparison of NIAS volatiles Examples 1-9. Examples 1-9 were conditioned at 120° C. for 4 hours. VOC content was reported as content of decene, dodecene, and tetradecane (C₁₀-C₁₄).

TABLE 5

| | NIAS Volatiles |
|---|---|
| Example | (ppmw) |
| 1 | 0 |
| 2 | 1.27 |
| 3 | 0.70 |
| 4 | 0.52 |
| 5 | 0.43 |
| 6 | 1.29 |
| 7 | 1.24 |
| 8 | 1.58 |
| 9 | 5.20 |

Table 5 and FIG. 3 show GC-MS VOC results for inventive Examples 3-5 (A3 formulations), which indicate a reduction of VOC content with a greater reduction as A3 concentration was increased.

Table 5 and FIG. 3 further show GC-MS VOC results for inventive Examples 6-9 (A1/A2 formulations), which show that increasing levels of A2 provided minimal to no improvement in VOC reduction for 25 ppm A1 and up to 100 ppm A2. Increasing levels of A2 to 500 ppm and 1000 ppm, respectively, indicated greater VOC content. It is believed, without wishing to be bound by any particular theory, that this increase in VOC content was due to production of 2,4-di-t-butyl phenol, as a byproduct of the A2-type additive.

These results suggest a favorable odor and/or flavor characteristics for bottles using A3 formulations. It is believed that other A2-type additive may produce better VOC reductions with the avoidance of producing the 2,4-di-t-butyl phenol byproduct.

TABLE 6

| | A2 | 2-Butene | 3-Decene | 3-Dodecene | Tetradecene |
|---|---|---|---|---|---|
| Example | (wt. %) | (ppmw) | (ppmw) | (ppmw) | (ppmw) |
| 2 | 0 | 0.15 | 0.44 | 0.49 | 0.17 |
| 3 | 0.5 | 0.11 | 0.16 | 0.31 | 0.11 |
| 4 | 1.0 | 0.20 | 0 | 0.24 | 0.10 |
| 5 | 2.0 | 0.24 | 0 | 0.16 | 0 |

A3 additives are known to absorb small molecules that cause bad taste and odor, such as ethylene and acetaldehyde, at low concentrations. Table 6 and FIG. 4 show the reduction in C₁₀-C₁₄ NIAS volatiles as the amount of A3 is increased. Examples 3-5 are believed to show that A3-type additives are also useful for absorption of C₁₀-C₁₄ NIAS volatiles. It is further believed that A3-type additives may provide a reduction of NIAS volatiles when added to a PCR blend having a higher initial the NIAS volatile content.

### —Color Index Testing (CIT, L*a*b*)

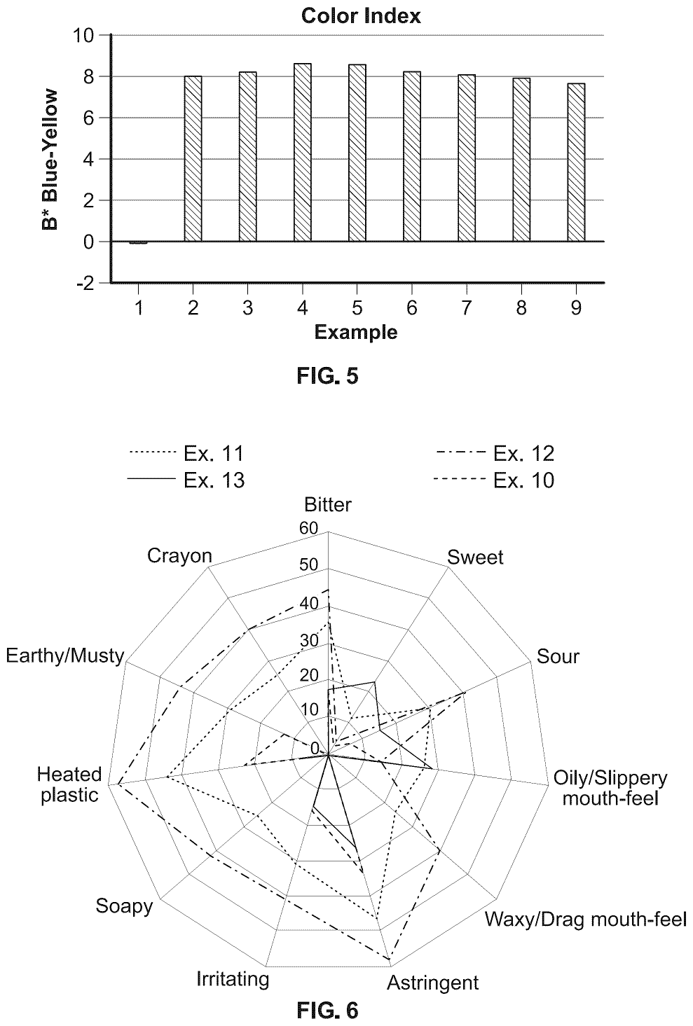

Table 7, below, and FIG. 5 show a comparison of b* blue-yellow for Examples 1-9. Yellowness index is a primary concern for blow molded articles and can influence consumer purchasing for food packaging generally for association with potential poor food quality. Yellowness in HDPE can generally appear from excessive heat or multiple heat histories to oxidize polymer chains and degrade antioxidant additives.

TABLE 7

| Example | B* Blue-Yellow |
|---|---|
| 1 | −0.09 |
| 2 | 7.98 |
| 3 | 8.20 |
| 4 | 8.63 |
| 5 | 8.57 |
| 6 | 8.22 |
| 7 | 8.06 |
| 8 | 7.90 |
| 9 | 7.65 |

Examples 3-5 (A3 formulations) showed an increase in yellowness increased with concentrations up to 2% A3, but such increases may be negligible compared to control Example 2 (PCR blend.

Examples 6-9 (A1/A2 formulations) indicate the yellowness index may be reduced with increased loading of the A2 additive up to 500 ppm and 1000 ppm, respectively. The decrease in yellowness index with 500 ppm and 1000 ppm A2 is improved compared to the control Example 2 (PCR blend), but still significantly more yellow than control Example 1 (HD).

Table 5 and FIG. 3 show GC-MS VOC results for inventive Examples 3-5 (A3 formulations), which indicate a reduction of VOC content with a greater reduction as A3 concentration was increased.

VOC content reduction was achieved using additive A3, while color improvement was achieved using additives A1 and A2 in combination. These results suggest that a combination of additives A1, A2, and A3 may reduce VOC content and improve color. It is further believed that the positive effects of A1, A2, and A3 may increase as the ratio of PCR1 to HD1 in the blend is further increased.

### —Water Taste Testing

Four water samples were prepared by exposure of clean water to each of the four polymer compositions. The four polymer compositions included a control example of a virgin polymer, two comparative compositions of the virgin polymer/PCR blends, and an inventive example of a virgin polymer/PCR blend with an additive. Samples were conditioned for organoleptic analysis by pouring spring water from a 5 gallon polyethylene terephthalate (PET) container into 58 g dairy style gallon samples and control containers. Each of the containers was approximately half filled with water and placed into an oven at 66° C. for 16 hours. The containers were then removed from the oven and allowed to cool for 24 hours at ambient room temperature (˜23° C.). Conditioned water from the sample and control containers was then poured into 8-ounce LLDPE cups for analysis by the panel.

A panel of ten individuals trained in organoleptic analysis was assembled and used a full descriptive analysis technique. Language was developed for use by panelists to fully describe the water samples as shown in Table 8.

TABLE 8

| | | Reference |
|---|---|---|
| Attribute | Definition | Material |
| Bitter | The basic taste, perceived on the | Caffeine in |
| | tongue, stimulated by substances | filtered |
| | such as quinine, caffeine, and | water |
| | certain other alkaloids. | |
| Sweet | The basic taste, perceived on the | Sucrose in |
| | tongue, stimulated by sugars and | filtered water |
| | high potency sweeteners. | |
| Sour | The basic taste, perceived on the | Citric acid |
| | tongue, stimulated by acids, such | in filtered |
| | as citric acid. | water |
| Oily/Slippery | The mouthfeel associated with an | Water = 0, |
| Mouthfeel | oily/slippery coating the palate | Crisco |
| | and teeth such as oils. | Vegetable |
| | | Oil = 150 |
| Waxy/Drag | The mouthfeel associated with a | concept |
| Mouthfeel | film coating the palate. | |
| Astringent | The drying effect the product has | Apple juice = 40, |
| | in the mouth. | Grape juice = 80 |
| Irritating | The stinging feeling on the tongue | concept |
| | and in the mouth. | |
| Soapy | The aroma associated with bar soap. | Fels-Naptha ™ |
| | | soap, grated |
| Heated | The chemical aroma associated with | concept |
| Plastic | heated plastic. | |
| Earthy/Musty | Musty flavor associated with | concept |
| | basements. | |
| Crayon | Aroma associated with crayons. | Crayola ™ |
| | | crayon |
| Overall | Rating the sample quality from low | concept |
| Quality | quality (higher plastic and off- | |
| | notes) to higher quality (none to | |
| | very low in plastic and off-notes). | |

The samples were independently rated on all sensory measures by each of the ten experienced panelists. Water samples were labeled with 3-digit codes, and water sample serving orders were rotated and balanced across panelists to anonymize the water samples. Each panelist completed evaluation of the first set prior to evaluating the subsequent two replications.

Samples were rated for overall quality from −7 (very low quality: high plastic and off-notes) to +7 (very high quality: none to very low plastic and low off-notes). All other sensory measures were rated on a 150-point scale from “none” to “very strong”. The interpretation of the scale was as follows: 0-20=none to low; 20-50=low-medium; 50-70=medium; 70-100=medium-high; 100-120=high; and 120-150=very high.

Data were analyzed using SenPAQ 2015 Version 6.03 statistical software with Analysis of Variance (ANOVA) followed by the Tukey honestly significant difference (HSD) procedure at the 95% confidence level. Xlstat Version 18.06 statistical software for Microsoft™ Excel utilized for Principal Component Analysis (PCA).

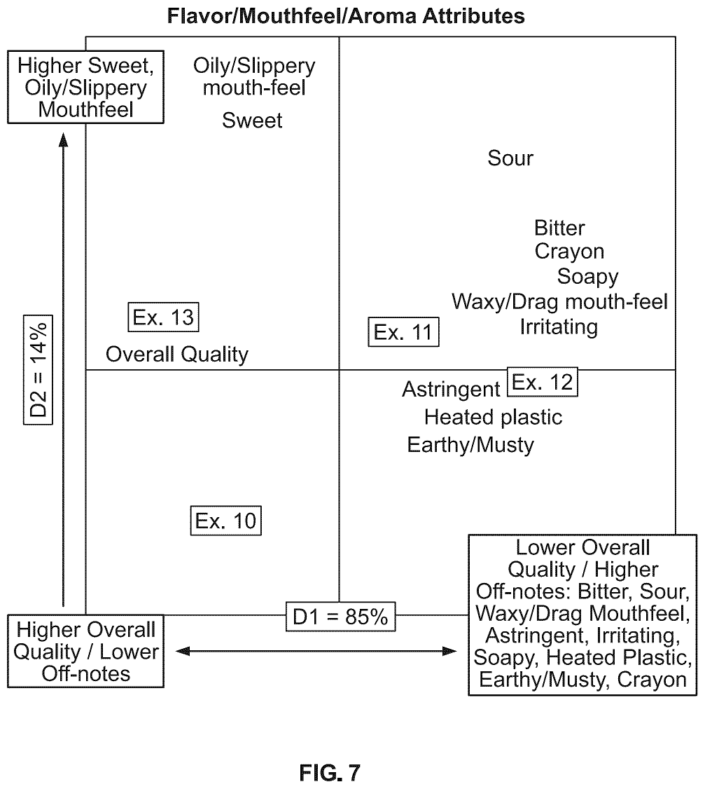

Table 9, below, and FIG. 6 and FIG. 7 show a comparison of Examples 10-13 prepared and analyzed as described above.

TABLE 9

| | Example | | | | HSD | |
|---|---|---|---|---|---|---|
| Attribute | 10 | 11 | 12 | 13 | at 95% | Prob. |
| HD1 (wt. %) | 100 | 75 | 50 | 49 | | |
| PCR1 (wt. %) | 0 | 25 | 50 | 49 | | |
| A3 (wt. %) | 0 | 0 | 0 | 2 | | |
| Bitter | 17.5 | 35.8 | 44.3 | 17.1 | 2.3 | 0.0001 |
| | (c) | (b) | (a) | (c) | | |
| Sweet | 2.8 | 11.2 | 3.8 | 23.0 | 3.7 | 0.0001 |
| | (c) | (b) | (c) | (a) | | |
| Sour | 6.5 | 30.3 | 40.8 | 15.1 | 2.8 | 0.0001 |
| | (d) | (b) | (a) | (c) | | |
| Oily/Slippery | 15.7 | 26.1 | 14.1 | 28.7 | 2.6 | 0.0001 |
| Mouthfeel | (b) | (a) | (b) | (a) | | |
| Waxy/Drag | 0.0 | 23.6 | 39.8 | 0.0 | 1.8 | 0.0001 |
| Mouthfeel | (c) | (b) | (a) | (c) | | |
| Astringent | 33.5 | 46.3 | 57.7 | 26.4 | 2.2 | 0.0001 |
| | (c) | (b) | (a) | (d) | | |
| Irritating | 16.0 | 30.9 | 41.1 | 14.5 | 2.7 | 0.0001 |
| | (c) | (b) | (a) | (c) | | |
| Soapy | 0.0 | 25.4 | 41.8 | 0.0 | 1.6 | 0.0001 |
| | (c) | (b) | (a) | (c) | | |
| Heated | 23.5 | 44.0 | 57.5 | 8.6 | 3.5 | 0.0001 |
| Plastic | (c) | (b) | (a) | (d) | | |
| Earthy/Musty | 12.8 | 29.0 | 43.7 | 0.0 | 2.1 | 0.0001 |
| | (c) | (b) | (a) | (d) | | |
| Crayon | 0.0 | 25.4 | 40.0 | 0.0 | 1.8 | 0.0001 |
| | (c) | (b) | (a) | (c) | | |
| Overall | 0.8 | −3.9 | −5.4 | 0.8 | 0.7 | 0.0001 |
| Quality | (c) | (d) | (a) | (b) | | |

N = 10 × 3 evaluations per sample
“HSD” is Tukey's HSD (Tukey's Honestly Significant Difference) which is a statistical technique used to determine which sample means are different from each other. The statistical level was set at 95% confidence for this study which is indicated “at 95%”.
Within an attribute, products sharing a common letter are not significantly different at the 95% confidence level as tested by Analysis of Variance (ANOVA) with Tukey's honestly significant difference (HSD) procedure for Post Hoc comparisons.

Table 9 shows the attribute intensities of Examples 10-13 and shows significant differences between the examples for all flavor/mouthfeel/aroma attributes. Inventive Example 13 and control Example 10 are lowest in bitter and irritating with no waxy/drag mouthfeel, soapy, or crayon. Inventive Example 13 was the highest in sweet and lowest in astringent, heated plastic and earthy/musty, while control Example 10 was the lowest in sour.

Comparative Example 11 and inventive Example 13 were the highest in oily/slippery mouthfeel, while comparative Example 12 and control Example 10 were lowest in sweet and oily/slippery mouthfeel.

Comparative Example 12 was the highest in bitter, sour, waxy/drag mouthfeel, astringent, irritating, soapy, heated plastic, earthy/musty and crayon, while comparative Example 11 is second highest in these attributes.

FIG. 6 shows a spider chart comparing the flavor/mouthfeel/aroma attribute intensities of Examples 10-13. There were significant differences between samples for all attributes.

Inventive Example 13 is the highest in sweet and the lowest in the negative notes of astringent, heated plastic and earthy/musty, while control Example 10 is second lowest in these attributes. Inventive Example 13 and control Example 10 are lowest in bitter and irritating with no waxy/drag mouthfeel, soapy and crayon. Example 10 is lowest in sour.

Comparative Example 11 and inventive Example 13 are highest in oily/slippery mouthfeel. Comparative Example 12 and control Example 10 are lowest in sweet and oily/slippery mouthfeel. Comparative Example 12 is highest in negative notes of bitter, sour, waxy/drag mouthfeel, astringent, irritating, soapy, heated plastic, earthy/musty and crayon. Comparative Example 11 is second highest in these attributes.

FIG. 7 shows Principal Component Analysis (PCA) of the samples and organoleptic attributes. PCA is a technique for analyzing large datasets containing a high number of dimensions/features per observation. Interpretability of data is improved by enabling the visualization of multidimensional data, while preserving the maximum amount of information. PCA is a statistical technique for reducing the dimensionality of a dataset by linearly transforming the data into a new coordinate system where (most of) the variation in the data can be described with fewer dimensions than the initial data. D1 and D2 are the first two dimensions of PCA for the examples herein. The first dimension (D1) explains the most variation between the attributes and the products possible within one dimension while the second dimension (D2) explains the second most variation within dimensions. PCA allows a view of all the attributes and their relationships to the products simultaneously, which in this case is 12 attributes representing a 12-dimensional space. Only 2-3 dimensions of space at a time can be understood, so PCA allows for that representation to be communicated in two dimensions at a time. For example, plots could be made for overall quality vs. heated plastic, overall quality vs. earthy/musty, etc., as well as heated plastic vs earthy/musty, etc. Therefore, PCA allows understanding of all of those relationships in a 2-D plot as shown.

Inventive Example 13 and Control Example 10 are more similar in profile with each other than with either of the other two examples. They are higher in overall quality and lower in negative attributes. Inventive Example 13 is highest overall quality and sweet with higher oily/slippery mouthfeel and the lowest values for astringent, heated plastic and earthy/musty. Control Example 10 is second highest in overall quality and lowest in sour.

Comparative Example 11 and Comparative Example 12 are more similar to each other than with either of the other two examples and have lower overall quality and are higher in negative attributes. These samples are higher in bitter, sour, waxy/drag mouthfeel, astringent, irritating, soapy, heated plastic, earthy/musty and crayon. Comparative Example 11 is higher in oily/slippery mouthfeel with second lowest overall quality. Comparative Example 12 is highest in bitter, sour, waxy/drag mouthfeel, astringent, irritating, soapy, heated plastic, earthy/musty and crayon and lowest in overall quality.

In sum, Examples 10-12 show that the blends produced by the addition of PCR resin to virgin polymer have poorer organoleptic attributes relative to the virgin polymer alone. However, use of the hydrophobic synthetic zeolite as an additive in blends of virgin polymers and PCR resin produces a composition having organoleptic attributes competitive with virgin polymers.

For the sake of brevity, only certain ranges are explicitly disclosed herein. However, in addition to recited ranges, any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents and references cited herein, including testing procedures, publications, patents, journal articles, etc., are herein fully incorporated by reference for all jurisdictions in which such incorporation is permitted and to the extent such disclosure is consistent with the description of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the processes, machines, means, methods, and/or steps described in the specification. As one of the ordinary skill in the art will readily appreciate from the disclosure of the present invention, processes, machines, means, methods, and/or steps, presently existing or later to be developed that perform substantially the same function or achieve substantially the same result as the corresponding embodiments described herein, may be utilized according to the present invention. Accordingly, the appended claims are intended to include within their scope such processes, machines, means, methods, and/or steps.

What is claimed is:

1. A composition comprising a homogenous matrix of a mixture of:
a) a polymer recyclate blend; and
b) an additive, comprising:
i) an organic phosphite antioxidant;
ii) a hindered phenol antioxidant;
iii) a hydrophobic synthetic zeolite; or
iv) a combination thereof;
wherein the mixture is subjected to compounding conditions sufficient to produce the homogenous matrix of the polymer recyclate blend and the additive.

2. The composition of claim 1, wherein the polymer recyclate blend comprises:
a) a polymer recyclate in an amount in the range of from 5 wt. % to 65 wt. %; and
b) a virgin HDPE component in an amount in the range of from 35 wt. % to 95 wt. %;
wherein wt. % is based on the total weight of the polymer recyclate and the virgin HDPE component.

3. The composition of claim 1, wherein the polymer recyclate blend comprises:
a) a polymer recyclate in an amount in the range of from 10 wt. % to 55 wt. %; and
b) a virgin HDPE component in an amount in the range of from 45 wt. % to 90 wt. %;
wherein wt. % is based on the total weight of the polymer recyclate and the virgin HDPE component.

4. The composition of claim 3, wherein:
a) the polymer recyclate comprises a first HDPE in an amount greater than or equal to 80 wt. %, based on the weight of the polymer recyclate;
b) the virgin HDPE component comprises a second HDPE in an amount greater than or equal to 80 wt. %, based on the weight of the virgin HDPE component; and
c) the first HDPE and the second HDPE are the same or different.

5. The composition of claim 4, wherein the first HDPE and/or the second HDPE are homopolymers.

6. The composition of claim 1, wherein:
a) the organic phosphite antioxidant is present in the mixture in an amount in the range of from 1 ppmw to 100 ppmw;
b) the hindered phenol antioxidant is present in the mixture in an amount in the range of from 10 ppmw to 5000 ppmw;
c) the hydrophobic synthetic zeolite is present in the mixture in an amount in the range of from 0.1 wt. % to 6.0 wt. %; or
d) a combination thereof;
wherein ppmw and wt. % are based on the total weight of the polymer recyclate and the virgin HDPE component.

7. The composition of claim 1, wherein:
a) the organic phosphite antioxidant is present in the mixture in an amount in the range of from 5 ppmw to 75 ppmw;
b) the hindered phenol antioxidant is present in the mixture in an amount in the range of from 25 ppmw to 4000 ppmw;
c) the hydrophobic synthetic zeolite is present in the mixture in an amount in the range of from 0.2 wt. % to 5.0 wt. %; or
d) a combination thereof;
wherein ppmw and wt. % are based on the total weight of the polymer recyclate and the virgin HDPE component.

8. The composition of claim 1, wherein the composition, when compared to the same composition excluding the additive, exhibits one or more of:
a) a reduced diameter swell (Ud) and/or weight swell (Uw), as measure by the Uniloy™ 5630 Dairy Mold Processability and Swell Test;
b) a reduced gel content, as measured by the Optical Controls System (OCS) Gel Count;
c) a reduction in volatile organic compounds (VOC) content from non-intentional added substances (NIAS), as measured by gas chromatography-mass spectrometry (GC-MS); and
d) a reduction in yellowness, as measured by Color Index Testing (CIT, L*a*b*).

9. The composition of claim 8, wherein:
a) the additive is a combination of the hindered phenol antioxidant and the organic phosphite antioxidant; and
b) the composition exhibits a reduction in yellowness.

10. The composition of claim 8, wherein:
a) the additive is the hydrophobic synthetic zeolite; and
b) the composition exhibits a reduction in VOC content.

11. The composition of claim 8, wherein:
a) the additive is a combination of the hindered phenol antioxidant, the organic phosphite antioxidant, and the hydrophobic synthetic zeolite; and
b) the composition exhibits a reduction in yellowness and a reduction in VOC content.

12. The composition of claim 1, wherein the compounding conditions are implemented in a compounding zone of an extruder or mixer and include one or more of temperature, pressure, and shear force.

13. The composition of claim 1, wherein the compounding conditions comprise a temperature in the range of from 125° C. to 300° C.

14. The composition of claim 1, wherein:
a) the organic phosphite antioxidant comprises di(2,4-di-tert-butylphenyl) pentaerithritol diphosphite;
b) the hindered phenol antioxidant comprises 2,5,7,8-tetramethyl-2-(4,8,12-trimethyltridecyl) chroman-6-ol; and
c) the hydrophobic synthetic zeolite comprises a 30% Zeolite silica-rich, powder identified by CAS #1318-02-1.

15. A method for improving the processability and/or organoleptic properties of a first polymer recyclate blend, the method comprising:
a) forming a mixture of the first polymer recyclate blend with an additive, wherein the additive comprises:
i) an organic phosphite antioxidant;
ii) a hindered phenol antioxidant;
iii) a hydrophobic synthetic zeolite; or
iv) a combination thereof; and
b) subjecting the mixture to compounding conditions sufficient to form a second recyclate polymer blend, wherein the second recyclate polymer blend is a homogenous matrix of the first recyclate polymer blend and the additive.

16. The method of claim 15, wherein the first recyclate polymer blend comprises:
a) a polymer recyclate in an amount in the range of from 5 wt. % to 65 wt. %; and
b) a virgin HDPE component in an amount in the range of from 35 wt. % to 95 wt. %;
wherein wt. % is based on the total weight of the polymer recyclate and the virgin HDPE component.

17. The method of claim 15, wherein the mixture comprises:
a) the organic phosphite antioxidant is present in an amount in the range of from 1 ppmw to 100 ppmw;
b) the hindered phenol antioxidant is present in an amount in the range of from 10 ppmw to 5000 ppmw;
c) the hydrophobic synthetic zeolite is present in an amount in the range of from 0.1 wt. % to 6.0 wt. %; or
d) a combination thereof;
wherein ppmw and wt. % are based on the total weight of the polymer recyclate and the virgin HDPE component.

18. The method of claim 15, wherein the second polymer recyclate blend, when compared to the first polymer recyclate blend, exhibits one or more of:
a) a reduced diameter swell (Ud) and/or weight swell (Uw), as measure by the Uniloy™ 5630 Dairy Mold Processability and Swell Test;
b) a reduced gel content, as measured by the Optical Controls System (OCS) Gel Count;
c) a reduction in volatile organic compounds (VOC) content from non-intentional added substances (NIAS), as measured by gas chromatography-mass spectrometry (GC-MS); and
d) a reduction in yellowness, as measured by Color Index Testing (CIT, L*a*b*).

19. The method of claim 15, wherein the compounding conditions are implemented in a compounding zone of an extruder or mixer and include one or more of temperature, pressure, and shear force.

20. The method of claim 15, wherein the compounding conditions comprise a temperature in the range of from 125° C. to 300° C.
